(19) United States
(12) Patent Application Publication
(10) Pub. No.: US 2007/0144159 A1
(43) Pub. Date: Jun. 28, 2007

(54) Control system for controlling a peripheral device mounted to a vehicle

(76) Inventor: Donald E. Sjolin, Granger, IN (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/634,034

(22) Filed: Dec. 5, 2006

Related U.S. Application Data
(60) Provisional application No. 60/742,450, filed on Dec. 5, 2005.

(51) Int. Cl. F16D 31/00

(52) U.S. Cl. 60/325

(57) ABSTRACT

A vehicular peripheral device control system includes a peripheral device, an input device, and a hydraulic control apparatus. The input device is coupled to the hydraulic control apparatus and when actuated generates an input to the hydraulic control apparatus. The peripheral device is coupled to the hydraulic control apparatus, which actuates the peripheral device in response to the input device generating the input to the hydraulic control apparatus.

### CROSS-REFERENCE TO RELATED APPLICATIONS

This application claims priority and the benefit of provisional application entitled CONTROL SYSTEM FOR CONTROLLING A PERIPHERAL DEVICE MOUNTED TO A VEHICLE, Ser. No. 60/742,450, filed Dec. 5, 2005, which is incorporated herein by reference in its entirety.

### TECHNICAL FIELD AND BACKGROUND OF THE INVENTION

The present invention relates to a control system for controlling a peripheral device on a vehicle, such as a peripheral device on a truck. More particularly, the present invention is directed to a control system for controlling a peripheral device, such as a valve, on a fire truck.

The present invention is particularly suitable for use on a fire truck that includes one or more peripheral devices, such as valves that have been heretofore actuated by manual push/pull linkages, rotary hand wheel linkages, electric motor operation, and/or air drive systems. Each of these systems has drawbacks. For example, electric motor actuation tends to be very expensive relative to the other systems and is subject to failures caused by wear, exposure, and corrosion of the electrical components. Mechanical linkage systems tend to be difficult to design due to the extreme distances, angles, and obstructions that exists between input controls and the valve being actuated by the mechanical linkage system. Furthermore, mechanical linkage systems have multiple joints, both linear and rotary linkages, and are difficult to design and achieve the mechanical advantage required to operate the valve, which can have extremely high operating torque characteristics. Air drive systems are typically limited to a full open position or a full close position and, therefore, do not allow for gating of the valve—that is accurate control of the valve in a partially open or closed position.

Further, NFPA standards require large diameter valves to use a slow-close device to ensure that the valve cannot be closed rapidly to avoid water hammer in the water delivery system—that is the pump, hose, handling nozzle, and monitor, etc.

Accordingly, there is a need for a system that will provide improved control over a peripheral device on a vehicle, such as a valve. Furthermore, when such device is a valve used on a fire truck or apparatus, the control system must be able to provide positional control of the valve in a partially open/closed condition and slow-close operation where required.

### SUMMARY OF THE INVENTION

Accordingly, the present invention provides an improved control system for actuating peripheral devices on a vehicle that avoids many of the drawbacks of the current systems while providing improved control over the peripheral device.

In one form of the invention a control system for controlling a peripheral device mounted to a vehicle includes an input device and a hydraulic control apparatus. The input device is coupled to the hydraulic control apparatus. When actuated the input device generates an input to the hydraulic control apparatus. The peripheral device is coupled to the hydraulic control apparatus, which actuates the peripheral device in response to the input device generating the input to the hydraulic control apparatus.

In one aspect, the input device may comprise a push/pull mechanism, a hand wheel device, or an electric input device. For example, the electric input device may comprise a user-actuatable electric input device, such as a button or a switch.

In another aspect, the hydraulic control apparatus includes a hydraulic hose and a hydraulic actuator, which is coupled to the peripheral device. For example, the hydraulic actuator may comprise a rotary hydraulic actuator or a linear hydraulic actuator.

According to yet another aspect, the peripheral device comprises a valve, such as a ball valve, a butterfly valve, or a gate valve.

In another form of the invention, a vehicle includes having a vehicle control system for controlling the vehicle, includes a peripheral device, which functions independently of the vehicle control system, an input device, and a hydraulic control apparatus coupled to the peripheral device. The hydraulic control apparatus receives input from the input device when the input device is actuated. The hydraulic control apparatus actuates the peripheral device in response to the input from the input device.

In one aspect, the peripheral device comprises a fire control valve, such as a ball valve, a butterfly valve, or a gate valve.

Accordingly, the present invention provides a hydraulic control system that provides increased control over a peripheral device, such as a valve, and allows for greater flexibility in the installation of the control system. These and other objects, advantages, purposes, and features of the invention will become more apparent from the study of the following description taken in conjunction with the drawings.

### DETAILED DESCRIPTION OF THE DRAWINGS

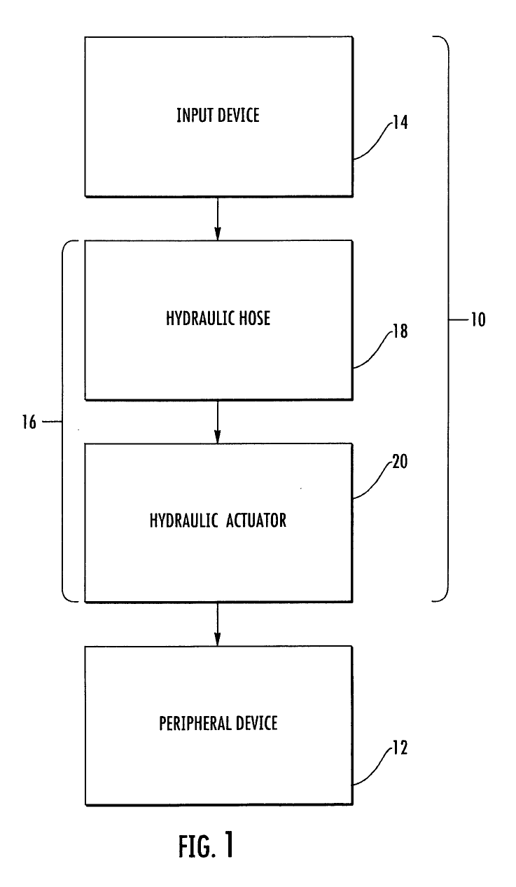

FIG. 1 is a schematic view of the control system of the present invention; and

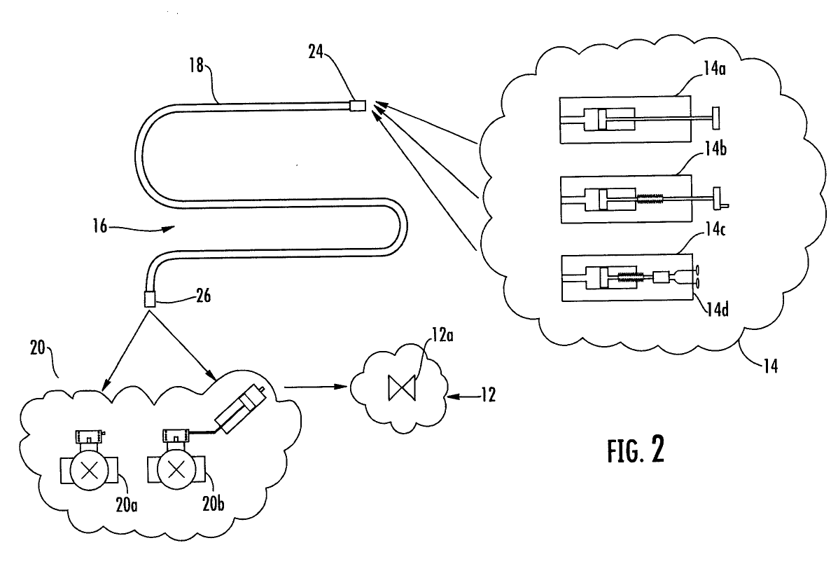

FIG. 2 is a second schematic of the control system of the present invention.

### DETAILED DESCRIPTION OF THE PREFERRED EMBODIMENTS

Referring to FIG. 1, the numeral 10 generally designates a control system of the present invention. Control system 10 is adapted to provide increased control over a peripheral device mounted to a vehicle, such as a valve on a fire truck. As will be more fully described below, control system 10 is flexible and may incorporate a variety of different input devices and actuation devices, which streamlines manufacturing and reduces costs and, further, allows for standardization of the installation. This standardization results in reduced truck build time and, further, can reduce the inventory requirements for the system manufacturer and the installer, such as a truck manufacture. As will be more fully understood from the description that follows, control system 10 greatly simplifies the installation and building of, for example, a fire truck by requiring less space and offering enhanced flexibility so that the system can be installed around other components on the vehicle.

Referring again to FIG. 1, control system 10 is adapted to control a peripheral device 12 that is mounted on an apparatus or vehicle, for example, a valve on a fire truck. Hereinafter, reference will be made to a fire truck, though it should be understood that the invention is not so limited. For example, peripheral device 12 may comprise a ball-style or butterfly-style valve 12a (FIG. 2) or a gate valve, which has heretofore been conventionally actuated by manual push/pull linkages, rotary hand wheel linkages, electric motor operation, or an air drive system. In the present invention, control system 10 includes an input device 14 and a hydraulic control apparatus 16, which is responsive to input from input device 14. For example, input device 14 may comprise a manual push/pull device 14a (FIG. 2), a hand wheel device 14b (FIG. 2), or an electric input device 14c, such as an electric actuator including an electric user-actuatable device 14d, for example an electric push button or switch, or an RF signal controlled input device.

Hydraulic control apparatus 16 includes a hydraulic hose 18 and a hydraulic actuator 20. Hydraulic hose 18 is coupled to the input device, for example, the manual push/pull device 14a, the hand wheel device 14b, or the electric input device 14c, on one end of the hose and coupled to hydraulic actuator 20 on the other end of the hose. For example, hydraulic actuator 20 may comprise a rotary actuator 20a or may comprise a linear hydraulic actuator 20b, which is coupled to peripheral device 12. Hydraulic hose 18 is preferably relatively flexible and, hence, provides greater flexibility when installing system 10. For example, hose 18 allows the connection path between the input device (14) and peripheral device 18 to be varied as needed depending on the configuration of the fire truck and the other components on the truck.

Hydraulic control apparatus 16 further includes a coupling device 24, which is configured to accept anyone of the standard input devices, such as the manual push/pull 14a, hand wheel device 14b, or electric input device 14c, as previously noted above. Coupling device 24 may be any of several conventionally available mechanism—quick connect couplings, screw or swage connect couplings, etc. In addition, hydraulic control apparatus 16 includes a single coupling device 26, which is adapted to couple hydraulic hose 18 to various valve actuators, as noted above, including a rotary hydraulic actuator 20a or a linear hydraulic actuator 20b.

By incorporating a flexible hydraulic hose 18 into control system 10, control system 10 allows the transfer of control input energy from input devices 14 to the peripheral device 20 to be achieved in less space than the conventional control systems. Further, as noted, hose 18 provides greater flexibility in the routing of the system through the fire truck. Moreover, with hydraulic actuation, control system 10 can generate a greater mechanical advantage for easy manual operation of a valve and, further, greater control over the valve. For example, the hydraulic actuation will permit gating of the valve and, further, can provide for a slow-close requirement. The slow-close requirement may be accommodated using a simple bleed-off orifice to control the rate at which the hydraulic energy is transferred between the input device 14 and peripheral device 12.

Although described primarily in reference to the operation of a valve on a fire truck, the present system may be used to control various peripheral devices on vehicles.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A vehicular peripheral device control system comprising:
a peripheral device;
an input device; and
a hydraulic control apparatus, said input device coupled to said hydraulic control apparatus, when actuated said input device generating an input to said hydraulic control apparatus, said peripheral device coupled to said hydraulic control apparatus, said hydraulic control apparatus actuating said peripheral device in response to said input device generating said input to said hydraulic control apparatus.

2. The control system according to claim 1, wherein said input device comprises a manual mechanism.

3. The control system according to claim 2, wherein said manual mechanism comprises a push/pull mechanism.

4. The control system according to claim 2, wherein said manual mechanism comprises a hand wheel device.

5. The control system according to claim 1, wherein said input device comprises an electric input device.

6. The control system according to claim 5, wherein said electric input device comprises an RF signal controlled input device.

7. The control system according to claim 5, wherein said electric input device comprises a user-actuatable electric input device, said user-actuatable electric input device including a button or a switch to thereby actuate said user-actuatable electric input device.

8. The control system according to claim 1, wherein said hydraulic control apparatus includes a hydraulic actuator, said hydraulic actuator coupled to said peripheral device.

9. The control system according to claim 8, wherein said hydraulic control apparatus further including a flexible hydraulic hose coupling said input device to said hydraulic actuator.

10. The control system according to claim 9, wherein said hydraulic actuator comprises a rotary hydraulic actuator.

11. The control system according to claim 9, wherein said hydraulic actuator comprises a linear hydraulic actuator.

12. The control system according to claim 1, wherein said peripheral device comprises a valve.

13. The control system according to claim 13, wherein said valve comprises a ball valve, a butterfly valve, or a gate valve.

14. A fire truck vehicle having a vehicle control system for controlling the vehicle, said vehicle comprising:
a peripheral device functioning independently of the vehicle control system;
an input device; and
a hydraulic control apparatus coupled to said peripheral device, said hydraulic control apparatus receiving input from said input device when said input device is actuated, and said hydraulic control apparatus actuating said peripheral device in response to said input.

15. The vehicle according to claim 14, wherein said hydraulic control apparatus includes a bleed-off orifice to control the rate at which hydraulic energy is transferred between input device and the peripheral device.

16. The vehicle according to claim 14, wherein said peripheral device comprises a fire control valve.

17. The vehicle according to claim 16, said hydraulic control apparatus including a flexible hydraulic hose and a hydraulic actuator, said hose coupled to said input device and coupled to said hydraulic actuator, and said actuator coupled to said valve.

18. The vehicle according to claim 17, wherein said hose includes a coupling device, said coupling device being configured to couple said hydraulic hose to one of several hydraulic actuators.

19. The vehicle according to claim 17, wherein said hose comprises a flexible hose.

20. A method of actuating a peripheral device on a vehicle, said method comprising:
providing a peripheral device on a vehicle, the peripheral device functioning independently from the vehicle control system;
providing an input device, the input device comprising a manual input device or an electric input device;
selectively generating input energy with the input device;
providing an actuator for actuating the peripheral device;
transferring the input energy from the input device to the actuator to thereby actuate the peripheral device through a hydraulic system.

21. The method according to claim 20, wherein said transferring the input energy includes transferring the input energy through a flexible hydraulic hose.

22. The method according to claim 21, wherein said providing an actuator includes providing a hydraulic actuator in communication with the hydraulic actuator in communication with the hydraulic hose, said transferring the input energy includes transferring the input energy through the hydraulic hose to the hydraulic actuator to thereby actuate the peripheral device.
